(19) United States
(12) Patent Application Publication
(10) Pub. No.: US 2009/0015764 A1
(43) Pub. Date: Jan. 15, 2009

(54) MULTI-DOMAIN VERTICAL ALIGNMENT LIQUID CRYSTAL DISPLAY PANEL

(75) Inventors: Sheng-Chung Su, Chiayi City (TW); Chen-Chi Lin, Chiayi County (TW); Yen-Yu Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/039,750

(22) Filed: Feb. 29, 2008

(30) Foreign Application Priority Data
Jul. 10, 2007 (TW) 96125026

(51) Int. Cl. G02F 1/1335

(52) U.S. Cl. 349/106

(57) ABSTRACT

A multi-domain vertical alignment liquid crystal display (MVA-LCD) panel including an active device array substrate, a color filter substrate and a liquid crystal layer is provided. The active device array substrate has pixel units. Moreover, the color filter substrate includes a substrate and color filter units. The color filter units are disposed on the substrate. Additionally, the liquid crystal layer is disposed between the active device array substrate and the color filter substrate. The liquid crystal layer above each of the pixel units has domain sets of different alignments.

### CROSS-REFERENCE TO RELATED APPLICATION

This application claims the priority benefit of Taiwan application serial no. 96125026, filed on Jul. 10, 2007. The entirety of the above-mentioned patent application is hereby incorporated by reference herein and made a part of this specification.

### BACKGROUND OF THE INVENTION

1. Field of the Invention

The present invention generally relates to a display panel. More particularly, the present invention relates to a multi-domain vertical alignment liquid crystal display (MVA-LCD) panel.

2. Description of Related Art

Nowadays, the multimedia technology has been well developed, which mostly benefits from the development on semiconductor devices and display apparatuses. As far as displays are concerned, liquid crystal displays (LCDs) with superior features, such as high definition, good space utilization, low power consumption and no radiation, have gradually become the mainstream of the market. In order to obtain better display quality, currently all LCDs are developed towards features such as high contrast ratio, no gray scale inversion, little color shift, high luminance and wide viewing angle. As for the wide viewing angle technique, the common techniques include, for example, in-plane switching LCD (IPS-LCD), twisted nematic LCD (TN-LCD) and the like.

FIG. 1 is a schematic cross-sectional view illustrating a conventional TN-LCD panel. Referring to FIG. 1, a conventional TN-LCD panel 100 is mainly constituted by a thin film transistor (TFT) array substrate 110, a color filter substrate 120 and a liquid crystal layer 130. The liquid crystal layer 130 is disposed between the TFT array substrate 110 and the color filter substrate 120. It should be noted that liquid crystal molecules 132 in the liquid crystal layer 130 appear twisted between the TFT array substrate 110 and the color filter substrate 120. Since the arrangement of the liquid crystal molecules 132 is asymmetrical, the brightness of the display frames seeing from different viewing angles would vary and even have gray level inversion. All these phenomena may cause color shift in a display frame so as to affect the display quality thereof.

FIG. 2 is a top view of a conventional color filter substrate. Referring to FIG. 2, a color filter substrate 120 has a plurality of red filter units 120a, green filter units 120b and blue filter units 120c. The red filter units 120a, the green filter units 120b and the blue filter units 120c are disposed on a substrate 122 and respectively arranged into stripes. It should be noted that the red filter units 120a, the green filter units 120b and the blue filter units 120c are respectively arranged into straight lines, and therefore words or lines displayed through the color filter substrate 120 are clear and sharp. However, general display frames in a normal state mostly display dynamic or static frames. An image thus displayed through the color filter substrate 120 has a visual effect not quite toned-down.

### SUMMARY OF THE INVENTION

In view of the above-mentioned, the present invention provides a multi-domain vertical alignment liquid crystal display (MVA-LCD) panel having good display quality.

As embodied and broadly described herein, the present invention provides an MVA-LCD panel including an active device array substrate, a color filter substrate and a liquid crystal layer. The active device array substrate has a plurality of pixel units. The color filter substrate includes a substrate and a plurality of color filter units. The color filter units are disposed on the substrate corresponding to the pixel units, and three adjacent color filter units form into a delta-shape. In addition, the liquid crystal layer is disposed between the active device array substrate and the color filter substrate. The liquid crystal layer above each of the pixel units has domain sets with various alignments.

According to one embodiment of the present invention, each of the color filter units has a plurality of strip-shaped bumps. At least one end of each of the strip-shaped bumps extends along boundaries of the color filter unit.

According to one embodiment of the invention, each of the pixel units has a patterned pixel electrode. The patterned pixel electrode has a plurality of continuous strip-shaped slits.

According to one embodiment of the present invention, the MVA-LCD panel further includes a plurality of spacers disposed between the active device array substrate and the color filter substrate. The spacers are disposed corresponding to an intersection of two adjacent color filter units.

According to one embodiment of the present invention, the color filter units include red filter units.

According to one embodiment of the present invention, the color filter units include green filter units.

According to one embodiment of the present invention, the color filter units include blue filter units.

Since the MVA-LCD panel has advantages such as the color filter units arranged into delta shapes and the liquid crystal layer divided into domain sets having various alignments, both the viewing angle of the display frame and the display quality of the dynamic and static images can be effectively improved.

In order to the make the aforementioned and other objects, features and advantages of the present invention more comprehensible, preferred embodiments accompanied with figures are described in detail below.

### BRIEF DESCRIPTION OF THE DRAWINGS

FIG. 1 is a schematic cross-sectional view illustrating a conventional TN-LCD panel.

FIG. 2 is a top view of a conventional color filter substrate.

FIG. 3A is a top view of the multi-domain vertical alignment liquid crystal display (MVA-LCD) panel according to the first embodiment of the present invention.

FIG. 3B is a schematic cross-sectional view of the MVA-LCD panel according to the first embodiment of the present invention.

FIG. 3C is a schematic view of a staggered arrangement of the bumps according to the first embodiment of the present invention.

FIG. 4 is a schematic view illustrating an arrangement of the color filter units according to the first embodiment of the present invention.

FIG. 5 is a top view of the MVA-LCD panel according to the second embodiment of the present invention.

### DESCRIPTION OF EMBODIMENTS

### The First Embodiment

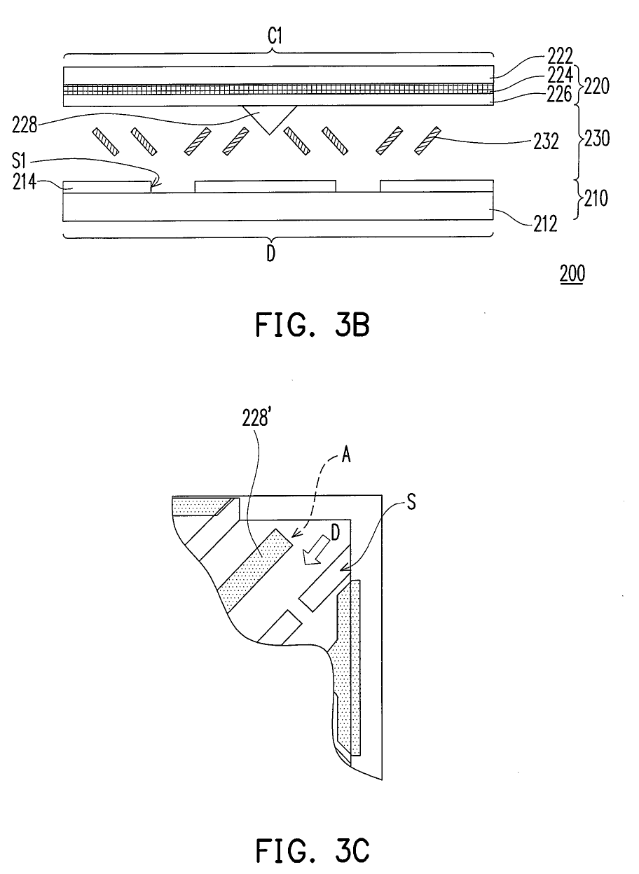

FIG. 3A is a top view of the multi-domain vertical alignment liquid crystal display (MVA-LCD) panel according to the first embodiment of the present invention. FIG. 3B is a schematic cross-sectional view of the MVA-LCD panel according to the first embodiment of the present invention. In order to emphasize the key points and keep the drawings as concise as possible, FIG. 3A omits a portion of elements and emphasizes only patterned pixel electrodes and strip-shaped bumps. Referring to both FIGS. 3A and 3B, an MVA-LCD panel 200 includes an active device array substrate 210, a color filter substrate 220 and a liquid crystal layer 230. The active device array substrate 210 has a plurality of pixel units P1. Generally, the pixel units P1 are mainly constituted by an active device (not illustrated) and patterned pixel electrodes 214 electrically connected with the active device. It should be noted that the patterned pixel electrodes 214 are located on a substrate 212 and have a plurality of slits S1.

In another aspect, the color filter substrate 220 is mainly constituted by a substrate 222 and a plurality of color filter units C1. Generally, the color filter units C1 may be red filter units, green filter units or blue filter units. Specifically, the color filter units C1 may be constituted by a filter film layer 224 and a common electrode layer 226. In practice, the filter film layer 224 disposed on the substrate 222 may be fabricated with red resin, green resin or blue resin so as to form filter units of different colors. It can be observed from FIG. 3B that the common electrode layer 226 is located on the filter film layer 224, and a plurality of strip-shaped bumps 228 is formed on the common electrode layer 226.

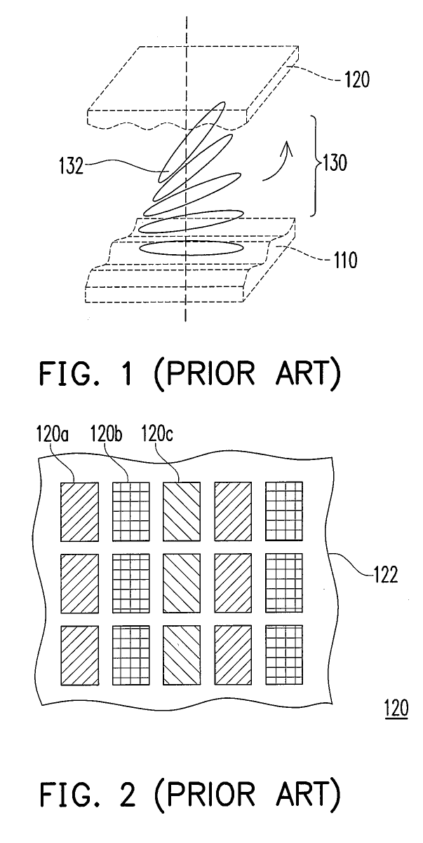

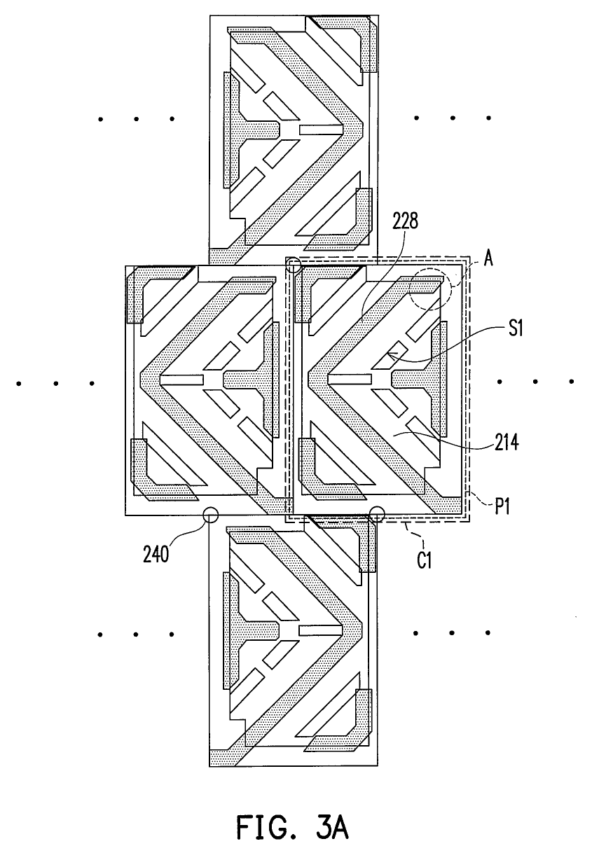

It should be explicated that an electric field used for driving liquid crystal molecules 232 may be formed between the common electrode layer 226 and the patterned pixel electrodes 214. Since the slits S1 and the strip-shaped bumps 228 can affect the electric field, the liquid crystal layer 230 may be divided into a plurality of domain sets having various alignments so that the liquid crystal molecules 232 have different tilting directions. For example, the liquid crystal molecules 232 may have four different alignments. Certainly, people of ordinary skill in the art pertinent to the present invention should know that the liquid crystal molecules 232 may also have more different alignments. The aforementioned only serves as an example and is not intended to limit the present invention. Since the liquid crystal molecules 232 have different tilting directions, all observers see from different viewing angles can have rather uniform display quality so that gray scale inversion is prevented from occurring in the display frame of the conventional TN-LCD 100 (as illustrated in FIG. 1).

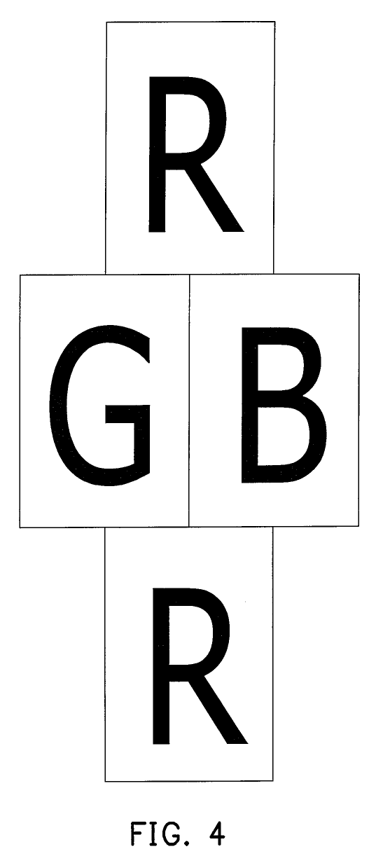

It should be noted that three adjacent color filter units C1 on the color filter substrate 220 as illustrated in FIG. 3A are in a delta arrangement, such as the three color filter units C1 every two of which have the shortest distance between them. Referring to FIG. 4, for example, the three color filter units C1 may be a red filter unit R, a green filter unit G and a blue filter unit B. The red filter unit R, the green filter unit G and the blue filter unit B are formed in a staggered disposition. Therefore, the frame displayed by the color filter substrate 220 of the present invention is more toned down. In addition, dynamic images can have a better display effect.

It should be noted that generally if there is misalignment in the assembling of the active device array substrate 210 and the color filter substrate 220, the strip-shaped bumps 228 on the common electrode layer 226 cannot be accurately aligned with the slits S1 on the patterned pixel electrodes 214. FIG. 3C is a schematic view illustrating a staggered arrangement of the bumps according to the first embodiment of the present invention. Specifically, a strip-shaped bump 228′ is displaced along a direction D because of a misalignment A as illustrated in FIG. 3C. Therefore, the liquid crystal molecules in A cannot be effectively controlled such that the display frame corresponding to A is likely to have dark stripes.

Referring to FIG. 3A, it is to be explicated that at least one end of the strip-shaped bump 228 (as the A illustrated in FIG. 3A) extends along boundaries of the color filter unit C1. Due to this design pattern, the misalignment of the active device array substrate 210 and the color filter substrate 220 is within a reasonable range. Areas where the strip-shaped bump 228 extends along the boundaries of the color filter unit C1 and then folds may serve as boundaries. Consequently, the arrangement of the liquid crystal molecules is effectively controlled so as to avoid the dark stripes in the display frames. Furthermore, the plurality of strip-shaped bumps 228 of the different color filter units C1 are combined with one another to form shapes similar to << although they may not be connected among themselves.

In practice, an MVA-LCD panel 200 of the present invention further includes a plurality of spacers 240 disposed between the active device array substrate 210 and the color filter substrate 220. Especially, in order to raise an aperture ratio, the photo spacer 240 are correspondingly disposed on an intersection of two adjacent color filter units C1 so as to further improve the display quality.

### The Second Embodiment

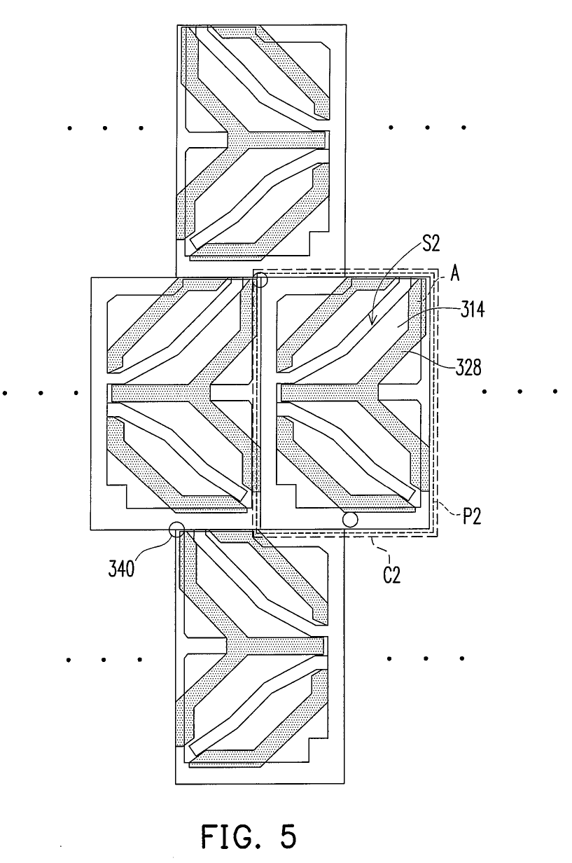

The present embodiment is similar to the first embodiment. In order to further improve the display quality, the slits on the patterned pixel electrodes in the present embodiment are continuous strip-shaped slits. FIG. 5 is a top view of the MVA-LCD panel according to the second embodiment of the present invention. Referring to FIG. 5, patterned pixel electrodes 314 have continuous strip-shaped slits S2 thereon, which aids in reducing the probability of dark stripes in the display frame. Moreover, the shape of strip-shaped bump 328 in the present embodiment is not intentionally limited. The strip-shaped bumps 328 formed into Y shapes as illustrated in FIG. 5 only serve to illustrate the present embodiment and are not intended to limit the present invention.

In summary, the MVA-LCD panel has advantages such as the color filter units arranged into delta shapes and the liquid crystal layer divided into domain sets having various alignments. Hence, both the viewing angle of the display frame and the display quality of the dynamic and static images are effectively improved. In addition, the areas where the strip-shaped bumps of the present invention extend along the boundaries of the color filter units and then fold can serve as the boundaries of the liquid crystal molecules. Therefore, the misalignment between the active device array substrate and the color filter substrate is within a reasonable range. The folding areas of the strip-shaped bumps still effectively control the arrangement of the liquid crystal molecules so as to avoid the dark stripes in the display frame. Furthermore, the strip-shaped bumps of different color filter units need not be connected with one another.

Although the present invention has been disclosed above by the embodiments, they are not intended to limit the present invention. Anybody ordinarily skilled in the art can make some modifications and alterations without departing from the spirit and scope of the present invention. Therefore, the protecting range of the present invention falls in the appended claims.

What is claimed is:

1. A multi-domain vertical alignment liquid crystal display (MVA-LCD) panel, comprising:
an active device array substrate, having a plurality of pixel units;
a color filter substrate, comprising:
a substrate;
a plurality of color filter units, disposed on the substrate corresponding to the pixel units, wherein three adjacent color filter units form into a delta shape; and
a liquid crystal layer, disposed between the active device array substrate and the color filter substrate, wherein the liquid crystal layer above each of the pixel units has a domain set of a different alignment.

2. The MVA-LCD panel as claimed in claim 1, wherein each of the color filter units has a plurality of strip-shaped bumps, and at least one end of each of the strip-shaped bumps extends along boundaries of the color filter unit.

3. The MVA-LCD panel as claimed in claim 1, wherein each of the pixel units has a patterned pixel electrode, and the patterned pixel electrode has a plurality of continuous strip-shaped slits.

4. The MVA-LCD panel as claimed in claim 1, further comprising a plurality of spacers disposed between the active device array substrate and the color filter substrate and corresponding to intersections of every two adjacent color filter units.

5. The MVA-LCD panel as claimed in claim 1, wherein the color filter units comprise red filter units.

6. The MVA-LCD panel as claimed in claim 1, wherein the color filter units comprise green filter units.

7. The MVA-LCD panel as claimed in claim 1, wherein the color filter units comprise blue filter units.
